(19) United States
(12) Patent Application Publication
(10) Pub. No.: US 2012/0264652 A1
(43) Pub. Date: Oct. 18, 2012

(54) DIRECTED HETEROBIFUNCTIONAL LINKERS

(75) Inventor: Richard P. Moerschell, Concord, CA (US)

(73) Assignee: Bio-Rad Laboratories, Inc., Hercules, CA (US)

(21) Appl. No.: 13/529,039

(22) Filed: Jun. 21, 2012

Related U.S. Application Data
(62) Division of application No. 11/843,580, filed on Aug. 22, 2007, now abandoned.
(60) Provisional application No. 60/823,280, filed on Aug. 23, 2006.
(60) Provisional application No. 60/857,751, filed on Nov. 7, 2006.

(51) Int. Cl. C40B 50/14; C40B 40/10

(52) U.S. Cl. 506/18; 506/30

(57) ABSTRACT

A heterobifunctional linker that comprises (a) a moiety capable of reversibly coupling the linker to a selected epitope of a target molecule; and (b) a moiety or moieties capable of irreversibly coupling the linker to the target, and optionally a moiety or moieties capable of irreversibly coupling the linker to a solid surface. Also described is a method of orienting molecules, such as proteins, with respect to a surface and to each other, employing such a linker, and an array of such oriented molecules, which may be the same or different.

### CROSS-REFERENCES TO RELATED APPLICATIONS

This application is a division of co-pending U.S. patent application Ser. No. 11/843,580, filed Aug. 22, 2007, which claims the priority of U.S. provisional applications 60/823,280 filed Aug. 23, 2006 of Richard P. Moerschell and 60/857,751 filed Nov. 7, 2006 of Richard P. Moerschell and Shai Nimri, both entitled “Directed Heterobifunctional Linkers”. All applications cited in this paragraph are incorporated herein by reference in their entireties.

### BACKGROUND OF THE INVENTION

This invention relates to substances known as “linkers”, that is, substances or molecules that can link to or couple to another substance, or molecule (herein referred to as the “target”) and optionally link or couple the target to yet another substance, which may be another molecule or a solid substrate or surface.

Linkers thus may be used, for instance, in labeling or tagging molecules, in capturing them onto a surface, or in joining them to other molecules of like or different type. A “bifunctional linker” contains two groups that can couple to other molecules and/or to a solid surface.

Typically linkers contain coupling moieties that will bind to any of a number of identical or similar sites on a target. This is adequate when the objective is to simply capture or link one molecule to another or to a surface without concern for orientation of one with respect to the other. However, it is not adequate when the objective is to orient one substance with respect to another, or with respect to other molecules of the same or different substance, or to link a molecule to a specific site on another.

### SUMMARY OF THE INVENTION

This invention comprises a linker that comprises

(a) a moiety capable of reversibly coupling the linker to a selected epitope of a target molecule; and

(b) a moiety or moieties capable of irreversibly coupling the linker to the target.

The linkers optionally also may contain a moiety or moieties capable of irreversibly coupling the linker to a solid surface or to another molecule that is different from the target, for example, a label.

In one aspect the invention also comprises a method of orienting molecules, such as proteins, with respect to a surface and to each other, and an array of such oriented molecules, which may be the same or different.

### BRIEF DESCRIPTION OF THE DRAWINGS

FIGS. 1A-1C′ depict generalized configurations of some embodiments of linkers of the preset invention.

FIG. 2 depicts one embodiment of a linker of the present invention coupled to a target molecule and to a solid surface.

### DETAILED DESCRIPTION OF THE INVENTION

In one aspect this invention comprises a linker that comprises

(a) a moiety capable of reversibly coupling the linker to a selected epitope of a target molecule; and

(b) a moiety or moieties capable of irreversibly coupling the linker to the target.

In a preferred embodiment the linker also comprises a moiety or moieties capable of irreversibly coupling to a solid surface (e.g., to a functional group on said surface) or to another molecule that is different from the target, for example, a label.

In its broadest aspect this invention resides in directed heterobifunctional linkers in the form of a molecule containing two types of moieties—an “affinity” moiety and one or more “coupling” moieties, with one or more “anchor” moieties optionally included as well. The affinity moiety is a moiety that is capable of reversibly binding to a particular epitope on a target molecule. The coupling moieties are moieties that are capable of binding irreversibly to a site (of which there may be one, or more than one) near the epitope on the target molecule. The anchor moiety or moieties, which are optional, are employed to irreversibly couple the directed heterobifunctional linker to a surface (e.g. to a functional group on said surface), or molecules other than the target, such as fluorophores and other labels.

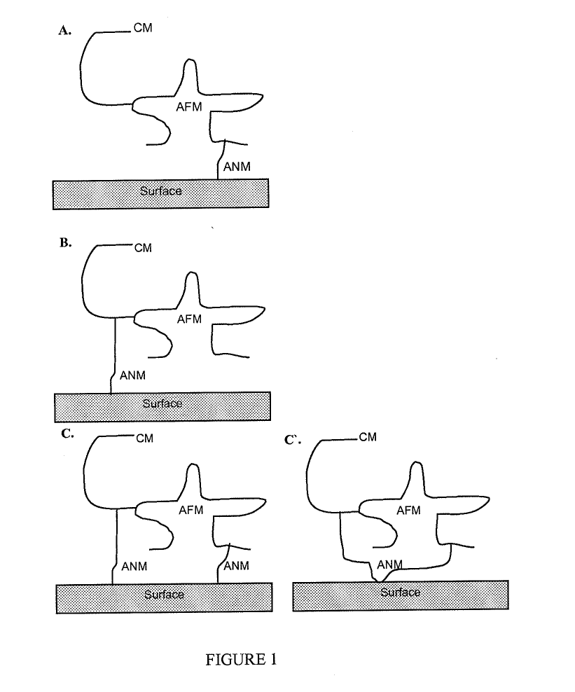

FIG. 1 depicts various linkers that include an anchor moiety. In that Figure, CM denotes a coupling moiety, AFM an affinity moiety, and ANM an anchor moiety. As shown in the parts of that Figure, the anchor moiety or moieties may be linked to the affinity moiety (FIG. 1A), to the coupling moiety (FIG. 1B) or to both of them (FIG. 1C and 1C′). As described below, the affinity moiety and the coupling moiety must have different chemistries.

Unlike conventional heterobifunctional linkers, which may bind to any of a number of sites on a target molecule, the directed heterobifunctional linkers of the present invention can be directed to irreversibly bind to a particular location on the target. This is achieved, as mentioned above, by reversible binding of the affinity moiety to an epitope in the proximity of that particular location, and irreversible binding of the coupling moiety to that location. If an anchor moiety is included, target molecules can be arrayed on a surface irreversibly in a uniform orientation. Examples of surfaces on which the target molecules can be arrayed are chip arrays, beads, and a cantilever.

Three examples of linkers according to the invention are described below.

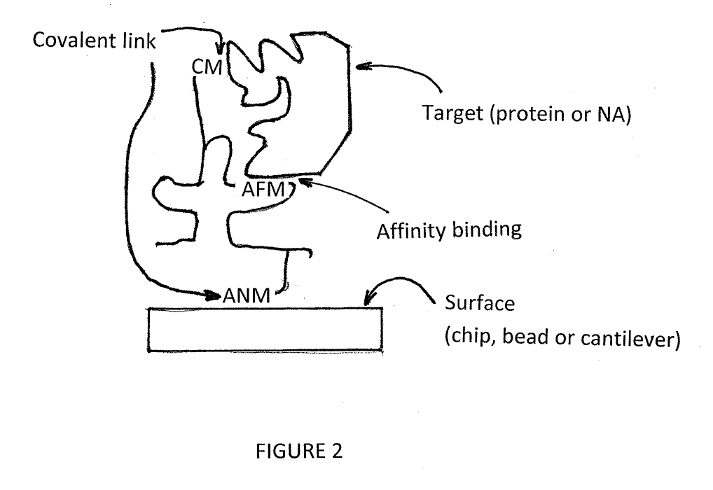

In one type of linker according to the invention, the affinity moiety is an affinity binding site on an aptamer. A coupling moiety is tethered to a particular base that is not located within the affinity binding site but is distant from it. This distance is important to the extent that if it is too small, the presence of the tethered coupling moiety could detrimentally affect the affinity binding site (for example by steric hindrance or perturbing the local secondary and tertiary structure) whereas if the distance is too great, then the coupling moiety would not be able to reach the target molecule for subsequent coupling. An anchor moiety is tethered to a different base that is, generally, more distant from the affinity binding site and far enough away that the anchor moiety would not be able to bind to the target molecule. Such a linker is illustrated in FIG. 2. There the affinity moiety is an aptamer having a site indicated in the figures as “AFM”, which reversibly couples to an epitope on the target molecule. Coupled to a base elsewhere on the aptamer is a coupling moiety (CM) that can couple irreversibly to the desired location on the target. As a coupling moiety, a linear molecule is used that has a protein or DNA binding moiety at one end (such as for example-NHS or an aldehyde) and is coupled to a base of the aptamer at the other end, for example by a tether. The coupling moiety has enough length and flexibility to reach and bind to a residue or base on the target molecule. An anchor moiety (ANM) is couples to the aptamer at yet another location

2) In a second type of linker, the affinity moiety is a unique site located on an antibody and a coupling moiety is attached to a particular residue of the antibody that is not located within the affinity moiety but is distant from it, as with the linker previously described. A linear molecule serves as a coupling moiety, the linear molecule having a protein or DNA binding moiety at one end (an NHS or aldehyde) and is coupled to a residue of the antibody at the other end. The coupling moiety has enough length and flexibility to reach and bind to a residue or base on the target molecule. Such a unique site could be positioned in a protein sequence using technology developed by Ambrx, Inc. (Ambrx, Inc. is a company that makes proteins using, besides the normal 20 amino acids and concomitant tRNA and tRNA synthetases, an addition tRNA and tRNA synthetase. In doing so, AMBRX can position a man-made residue at any position within a polypeptide. This man-made residue can have an azide on it, for example. With an azide at a particular position in the antibody, the coupling moiety can be attached specifically to that azide via click chemistry. The coupling moiety can be designed to have the desired protein or DNA binding moiety at one end and an alkyne at the other, since an alkyne can bind to azides via click chemistry.)

3) In a third type of linker, the affinity moiety is a nickel-nitrilotriacetic acid (Ni-NTA) complex or a similar complex having affinity to oligohistidine-tagged (his-tagged) proteins. The coupling moieties are carboxylic groups or other groups capable of amine coupling. At the first stage, the protein is captured to the surface by the Ni-NTA complex, optionally directly from its media of expression; thus, prior purification steps are spared. Then, amine groups in the protein are reacted to form covalent bonds with the coupling moieties, optionally by activation, e.g. activation of carboxylic groups. The coupling moieties may be part of a surface-bound polymer, e.g. carboxylic groups of alginic acid or other polysaccharide. More preferably, the coupling moiety is designed to react and form a covalent bond with the end amine group of the amino-terminal his-tag. The nickel atom may be then extracted from the NTA complex, e.g. by EDTA. Since the protein is covalently bound at this stage, it will not become disconnected from the surface. The advantage of this act is elimination of non-specific binding (NSB) to the nickel atoms, if the surface is used for interacting the bound protein with other proteins, e.g. in biosensor application.

While the target molecule is illustrated above as either DNA or a protein, the target molecule may be another type of polymer, for instance, a carbohydrate. The features required for the target molecule are (1) that it contain an affinity binding site, (2) that there be an affinity moiety that can bind the target at the affinity binding site on the target, and (3) that there be an available chemistry to form a bond between the coupling moiety and the target. For example, the affinity moiety can be a lectin and the target can be a carbohydrate.

Prior art linkers simply bind to whatever base or residue on the target that the linkers can bind to. The directed heterobifunctional linkers of the present invention differ in that due to the reversible binding of the affinity moiety at a particular epitope on the target the coupling moiety is restricted to binding only to sites near the epitope. This allows oriented coupling of a target molecule, for instance. Suitable affinity moieties are those that will couple to the target molecule in any type of non-covalent affinity interaction. Examples of affinity moieties that can be used in this invention are avidin, biotin, antibody, aptamer[s?], synthetic high-affinity ligands (SHALS), “his” tag, GST, MBP, and protein A.

The linker may also comprise (or be coupled to by an anchor moiety) a detectable label, for instance, a fluorophore, chemophore or radioactive isotope.

When the linker also includes an anchor moiety, the binding of the affinity moiety to a particular location on the target molecule additionally ensures the orientation of the target molecule relative to the anchor attachment point. For example, the anchor moiety may be coupled with a label so that a selected protein in a mixture of proteins can be tagged or labeled because it has an epitope near the binding site while other proteins do not have such a site.

The anchor and coupling moieties are moieties that engage in conventional coupling chemistries. The sole requirement is directionality, i.e., only an anchor moiety will bind to the anchor attachment point. For example, if the anchor attachment point is a thiol, the anchor moiety is a maleimide and the coupling moiety is neither a maleimide nor a thiol. This is because if a maleimide were used as the coupling moiety, the coupling moiety would also react with the anchor attachment point and if a thiol were used as the coupling moiety, the anchor moiety would react with the coupling moiety to form a polymer of directed heterobifunctional linkers strung together.

The following are examples of chemistries that meet the specifications of the present invention and those that do not:

| | Acceptable | Unacceptable | |
|---|---|---|---|
| Anchor | Coupling | Coupling | |
| Moiety | Moieties | Moieties | Note |
| Maleimide | Aldehyde/ | Maleimide or | Maleimide |
| | Schiff base | thiol | reacts |
| | Azide (click chem) | | with thiol |
| | Alkyne (click chem) | | |
| Aldehyde/ | Maleimide | Aldehyde/ | Aldehyde reacts |
| Schiff base | Azide (click chem) | Schiff base | with amines |
| | Alkyne (click chem) | or amine | |
| Azide | Schiff | Azide or alkyne | Azide reacts |
| (click) | base/borohydride | | with alkynes |
| | Maleimide | | |

Directed heterobifunctional linkers in accordance with the present invention are synthesized by conventional chemistries. For example, a synthetic affinity molecule (such as an aptamer or SHALS) is synthesized with one or more anchor moieties and one or more coupling moieties. Native affinity molecules, such as antibodies and protein G, can be converted to directed heterobifunctional linkers using standard bifunctional linkers. For example, a maleimide linker, using a maleimide/succinimidyl bifunctional linker, can be attached to provide a maleimide group. An alkyne linker, using an aldehyde/carbodiimide bifunctional linker, would be attached to provide an alkyne group.

The foregoing descriptions are offered primarily for purposes of illustration. Further modifications, variations and substitutions that still fall within the spirit and scope of the invention will be readily apparent to those skilled in the art. All such modifications coming within the scope of the appended claims are intended to be included therein.

All publications, patents, and patent applications cited herein are hereby incorporated by reference in their entirety for all purposes.

What is claimed is:

1. A method for producing a plurality of molecules coupling to a solid surface wherein the molecules are oriented with respect to each other, comprising
(i) contacting the plurality of molecules with a linker comprising (a) a moiety capable of reversibly coupling to a selected epitope of the plurality of molecules; (b) a moiety or moieties capable of irreversibly coupling to the plurality of molecules, and (c) a moiety or moieties capable of irreversibly coupling to a solid surface, and
(ii) contacting the product of step (i) with the surface.

2. A method according to claim 1 in which the oriented molecules are identical molecules.

3. A method according to claim 1 in which the oriented molecules are different from each other.

4. A method according to claim 1 in which the oriented molecules are proteins.

5. A method according to claim 4 in which the proteins are different from each other.

6. An array of oriented molecules coupled to a solid surface in which the coupling is performed using a linker that comprises (a) a moiety capable of reversibly coupling to selected epitope of a target molecule of interest, (b) a moiety or moieties capable of irreversibly coupling to the target molecule and (c) a moiety or moieties capable of irreversibly coupling to a solid surface.

7. An array of oriented proteins according to claim 6.

8. An array of oriented proteins according to claim 6 that are different from each other.
